(19) United States
(12) Patent Application Publication
(10) Pub. No.: US 2018/0037135 A1
(43) Pub. Date: Feb. 8, 2018

(54) Method of Controlling Speed of Electric Vehicle in Keeping with Controller Temperature

(71) Applicants: National Cheng Kung University, Taipei (TW); Delta Electronics Inc., Taipei (TW)

(72) Inventor: Chun-Yi Lee, Taipei (TW)

(21) Appl. No.: 15/226,062

(22) Filed: Aug. 2, 2016

(51) Int. Cl. B60L 15/10; B60L 3/00; B60L 15/20

(52) U.S. Cl. CPC B60L 15/10; B60L 15/20; B60L 3/0084; B60L 2240/36; B60L 2240/421

(57) ABSTRACT

A method is provided to control speed of an electric vehicle. On operating the electric vehicle, temperature of a controller of the electric vehicle is monitored. The temperature of the controller monitored is compared with a preset temperature to find whether the temperature is too high. When the temperature of the controller is found to be too high, the current provided to the controller is reduced. Thus, the speed of the electric vehicle is lowered down while the temperature of the controller is further lowered down. Hence, good safety is achieved on operating the electric vehicle and use-life of the electric vehicle is prolonged.

### TECHNICAL FIELD OF THE INVENTION

The present invention relates to controlling speed of an electric vehicle; more particularly, relates to controlling the speed in keeping with temperature of a controller for achieving good safety on operating the electric vehicle and prolonging use-life of the electric vehicle.

### DESCRIPTION OF THE RELATED ART

A common controller for an electric vehicle will generate heat on operating. If the heat is not dissipated immediately, the controller may not be operated as normal, and may be even burnt. Therefore, the electric vehicle must monitor temperature of the controller in a real time for achieving security on driving and further prolonging use-life of the electric vehicle.

However, the electric vehicle is mostly not set up with a device to detect the temperature of the controller. Therefore, on operating the electric vehicle, security is bad and use-life of the electric vehicle becomes short.

Hence, the prior art does not fulfill all users' requests on actual use.

### SUMMARY OF THE INVENTION

The main purpose of the present invention is to control speed of an electric vehicle in keeping with temperature of a controller for achieving good safety on operating the electric vehicle and prolonging use-life of the electric vehicle.

To achieve the above purposes, the present invention is a method of controlling speed of an electric vehicle in keeping with controller temperature, where the electric vehicle has an actuating device; the actuating device comprises a controller, a motor, at least two wheels and a power unit; the motor is connected to the controller; the wheels are connected to the motor; the power unit is connected to the controller; and the method comprises steps of: (a) during operating the electric vehicle, continuously detecting temperature of the controller generated; (b) comparing the temperature with a preset temperature for determining whether temperature of the controller is too high; and, (c) when the temperature of the controller is determined to be too high, reducing a current provided to the motor to lower down speed of the electric vehicle and further reduce the temperature of the controller. Accordingly, a novel method of controlling speed of an electric vehicle in keeping with controller temperature is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention; and

FIG. 2 is the view showing the interactions between the function blocks in the preferred embodiment.

### DESCRIPTION OF THE PREFERRED EMBODIMENT

The following description of the preferred embodiment is provided to understand the features and the structures of the present invention.

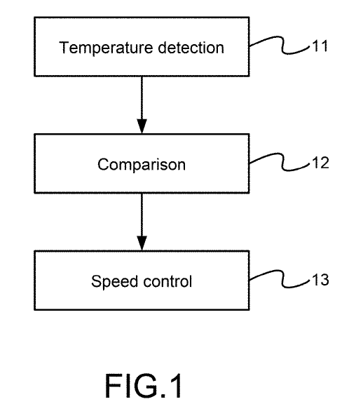

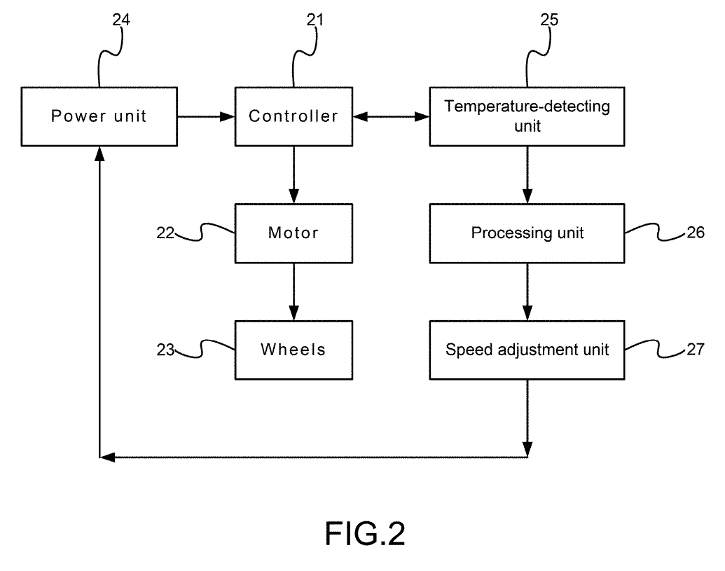

Please refer to FIG. 1 and FIG. 2, which are a flow view showing a preferred embodiment according to the present invention; and a view showing interactions between function blocks in the preferred embodiment. As shown in the figures, the present invention is a method of controlling speed of an electric vehicle in keeping with controller temperature. The electric vehicle has an actuating device. The actuating device comprises a controller 21, a motor 22, at least two wheels 23 and a power unit 24. The motor 22 is connected to the controller 21. The wheels 23 are connected to the motor 22. The power unit 24 is connected to the controller 21. The method according to the present invention comprises the following steps:

(a) Temperature detection 11: During operating the electric vehicle, temperature of the controller 21 generated is continuously detected by a temperature-detecting unit 25.

(b) Comparison 12: The temperature is transferred to a processing unit 26. The processing unit 26 receives the temperature from the temperature-detecting unit 25 to compare the temperature with a preset temperature stored in the processing unit 26 and determine whether the temperature of the controller 21 is too high. Therein, the preset temperature is 57 celsius degrees (° C.)˜65° C. while 59° C. is preferred.

(c) Speed control 13: When the temperature of the controller 21 is too high, the processing unit 26 drives a speed adjustment unit 27 to cut down a current supplied by the power unit 24 to the motor 22. When the temperature of the controller 21 detected in step (b) is 55° C.˜72° C., the speed adjustment unit 27 is driven by the processing unit 26 to adjust the current provided by the power unit 24 to the motor 22 to limit a highest speed of the electric vehicle to 45 kilometers (km). When the temperature of the controller 21 detected in step (b) is 65° C.˜82° C., the speed adjustment unit 27 is driven by the processing unit 26 to adjust the current provided by the power unit 24 to the motor 22 to limit the highest speed of the electric vehicle to 33 km. When the temperature of the controller 21 detected in step (b) is higher than 82° C., the speed adjustment unit 27 is driven by the processing unit 26 to adjust the current provided by the power unit 24 to the motor 22 to limit the highest speed of the electric vehicle to 8 km. After the temperature of the controller 21 detected is lowered down, the highest speed of the electric vehicle is restored to the related preset value. Thus, by reducing speed when the temperature of the controller 21 is too high, good safety is achieved and use-life of the electric vehicle is prolonged.

To sum up, the present invention is a method of controlling speed of an electric vehicle in keeping with controller temperature, where good safety is achieved on operating an electric vehicle and use-life of the electric vehicle is prolonged.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of controlling speed of an electric vehicle in keeping with controller temperature, said electric vehicle having an actuating device, said actuating device comprising a controller, a motor, at least two wheels and a power unit, said motor being connected to said controller, said wheels being connected to said motor, said power unit being connected to said controller, the method comprising steps of:
(a) during operating said electric vehicle, continuously detecting a temperature of said controller thus generated;
(b) comparing said temperature with a preset temperature to process calculation to determine whether said temperature of said controller is too high during operating said electric vehicle; and
(c) when said temperature of said controller is determined to be too high, reducing a current provided to said motor to lower down speed of said electric vehicle and further reduce said temperature of said controller.

2. The method according to claim 1,
wherein, in step (a), a temperature-detecting unit is connected to said controller to detect said temperature.

3. The method according to claim 1,
wherein, in step (b), a processing unit is connected to a temperature-detecting unit connected to said controller to compare said temperature with said preset temperature and determine whether said temperature of said controller is too high.

4. The method according to claim 1, wherein, in step (b), said preset temperature is 57° C.˜65° C. while 59° C. is preferred.

5. The method according to claim 1,
wherein, in step (c), a speed adjustment unit is connected to a power unit and a processing unit; and
wherein, when said temperature of said controller is too high, said speed adjustment unit is driven by said processing unit to reduce said current provided by said power unit to said motor to lower down said speed of said electric vehicle in keeping with said temperature of said controller.

6. The method according to claim 5,
wherein, when said temperature of said controller is 55° C.˜72° C., said current is adjusted to limit a highest speed of said electric vehicle to 45 kilometers (km).

7. The method according to claim 5,
wherein, when said temperature of said controller is 65° C.˜82° C., said current is adjusted to limit a highest speed of said electric vehicle to 33 km.

8. The method according to claim 5,
wherein, when said temperature of said controller is higher than 82° C., said current is adjusted to limit a highest speed of said electric vehicle to 8 km.
